(19) United States
(12) Patent Application Publication
(10) Pub. No.: US 2017/0262972 A1
(43) Pub. Date: Sep. 14, 2017

(54) GENERATING VOXEL REPRESENTATIONS AND ASSIGNING TRUST METRICS FOR ENSURING VERACITY FOR USE WITH MULTIPLE APPLICATIONS

(71) Applicant: INTEL CORPORATION, Santa Clara, CA (US)

(72) Inventors: ROBERT ADAMS, Lake Oswego, OR (US); BRADLEY JACKSON, Hillsboro, OR (US); IGNACIO J. ALVAREZ, Portland, OR (US); SRIDHAR UYYALA, Hillsboro, OR (US); DEEPAK S. VEMBAR, Portland, OR (US)

(21) Appl. No.: 15/116,919

(22) PCT Filed: Mar. 25, 2016
(86) PCT No.: PCT/US16/24336

§ 371 Date: Aug. 5, 2016

Related U.S. Application Data
(60) Provisional application No. 62/250,846, filed on Nov. 4, 2015.

(51) Int. Cl. G06T 7/00; G06T 7/187; G06T 15/08

(52) U.S. Cl. CPC G06T 7/0002; G06T 15/08; G06T 7/187; G06T 2215/16; G06T 2207/10004; G06T 2207/10032; G06T 2207/10028; G06T 2207/10048

(57) ABSTRACT

A mechanism is described for facilitating generation of voxel representations and assignment of trust metrics according to one embodiment. A method of embodiments, as described herein, includes detecting, by a computing device, a plurality of data sources hosting image capturing devices capable of capturing images of objects in a space, where the images are capable of being received by the computing device. The method may further include tagging trust metrics to the images based on credibility of the plurality of data sources, where a trust metrics to indicate veracity of a corresponding image. The method may further include aggregating the images into an aggregated image representation, and generating a voxel representation of the aggregated image representation such that the images are presented as voxel images, where veracities of the voxel images are secured based on tagging of the trust metrics to their corresponding images.

### CLAIM OF PRIORITY

This application claims priority to U.S. Provisional Patent Application No. 62/250,846, Attorney Docket No. 42P92733Z, entitled ASSIGNING TRUST LEVELS TO VOXELS BASED ON SOURCES OF CAPTURE AND GENERATING VOXEL REPRESENTATION OF WORLD FOR MULTIPLE APPLICATIONS, by Robert Adams, et al., filed Nov. 4, 2015, now pending, the benefit of and priority to which are claimed thereof and the entire contents of which are incorporated herein by reference.

### FIELD

Embodiments described herein generally relate to computers. More particularly, embodiments relate to facilitating generation of voxel representations and assignment of trust metrics for ensuring veracity for use with multiple applications.

### BACKGROUND

Conventional representations are mesh-based that define spaces with points and surfaces, where this reliance on points and surfaces for generating image representations is regarded as difficult and inefficient; for example, mesh-based representations are particularly cumbersome when combined into creating a view of a world space.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates a computing device employing a trustworthy voxel representation mechanism according to one embodiment.

FIG. 2 illustrates a trustworthy voxel representation mechanism according to one embodiment.

FIG. 3 illustrates a use-case scenario according to one embodiment.

FIG. 4 illustrates a method for facilitating generation and safeguarding veracity of voxel representations according to one embodiment.

FIG. 5 illustrates computer environment suitable for implementing embodiments of the present disclosure according to one embodiment.

FIG. 6 illustrates a method for facilitating dynamic targeting of users and communicating of message according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments provide for a novel technique for defining a service that models real world images in voxels, where such a model is generated from publicly available image sources as well as dedicated private sources, making the model available to software applications for interaction and understanding of the real world. These public and/or private sources may include or be associated with any number and type of computing devices having any number and type of image capturing device, such as cameras, etc. For brevity and clarity, in some cases, term “source” may be interchangeably referred to as “entity” (e.g., individuals, organizations, companies, government agencies, etc.), “computing device”, “satellite”, “data capturing device”, ‘cameras”, and/or the like. For example, a voxel representation of the world may be easier to generate from various public and/or private images (such as multiple images obtained from multiple image capturing devices, such as personal cameras, government satellites, etc.) as opposed to when used with conventional representations, such as common object representations, mesh representations, etc. Further, for example, a service may be created using various images to generate a voxel representation of the world, where this voxel representation may then be provided to various software applications to use the voxel representation in offering various services, such as mapping, navigation, interaction, physical simulation, etc., relating to the real world.

Embodiments further provide for a novel technique for assigning trust levels to object space voxel representations that are based on and obtained from various sources of data and generating of particular space representations. In one embodiment, trust levels may serve as parameters for data origins or sources, which may then be used in scene reconstruction processes to provide latest updates on a three-dimensional (3D) scene based on display-defined criteria.

Further, embodiments provide for voxel representations of objects (e.g., 3D physical objects) for real world and/or virtual world representations that are easily generated from views or images from any number and type of data sources, such as cameras. To ensure the veracity of voxel representations by aggregating images from multiple data sources, in one embodiment, trust metrics corresponding to trust levels are tagged to various portions, such as images or voxels, of voxel representations based on the veracity of their corresponding data sources, such as source A being a government satellite, source B being a commercial camera, source C being a personal/user camera, etc. Conventional techniques, such as meshed representations require complex and inefficient analysis and computations for how a space is filled (such as recognition of surfaces or identification of whole objects).

It is contemplated and to be noted that embodiments are not limited to any particular number and type of powered devices, unpowered objects, software applications, application services, customized settings, etc., or any particular number and type of computing devices, networks, deployment details, etc.; however, for the sake of brevity, clarity, and ease of understanding, throughout this document, references are made to various sensors, cameras, microphones, speakers, display screens, user interfaces, software applications, user preferences, customized settings, mobile computers (e.g., smartphones, tablet computers, etc.), communication medium/network (e.g., cloud network, the Internet, proximity network, Bluetooth, etc.), but that embodiments are not limited as such.

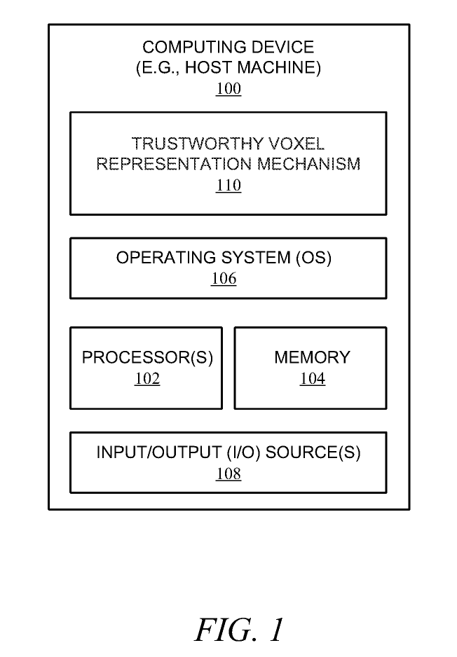

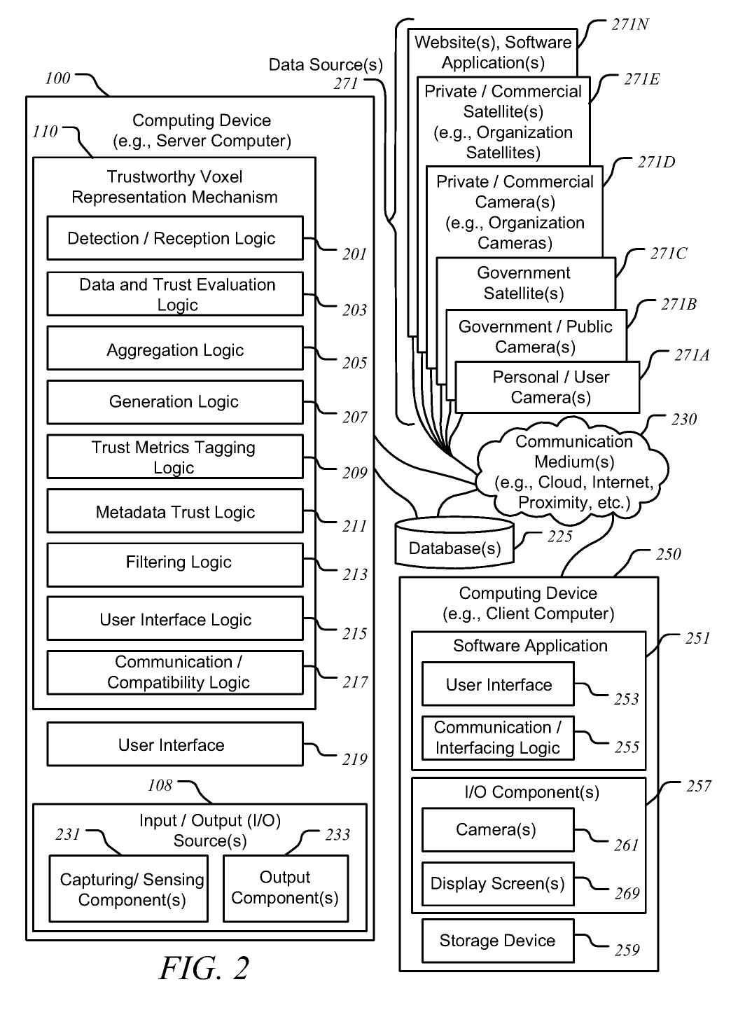

FIG. 1 illustrates a computing device 100 employing a trustworthy voxel representation mechanism (“voxel mechanism”) 110 according to one embodiment. Computing device 100 (e.g., server computer, desktop computer, mobile computer, etc.) serves as a host machine for hosting voxel mechanism 110 that includes any number and type of components, as illustrated in FIG. 2, to facilitate smart generation of voxel representations and assigning trust levels to such voxel representations based on, for example, various sources or origins of images that are used for composing voxel representations, as will be further described throughout this document.

Computing device 100 may include any number and type of data processing devices, such as large computing systems, such as server computers, desktop computers, etc., and may further include set-top boxes (e.g., Internet-based cable television set-top boxes, etc.), global positioning system (GPS)-based devices, etc. Computing device 100 may include mobile computing devices serving as communication devices, such as cellular phones including smartphones, personal digital assistants (PDAs), tablet computers, laptop computers (e.g., Ultrabook™ system, etc.), e-readers, media internet devices (MIDs), media players, smart televisions, television platforms, intelligent devices, computing dust, media players, head-mounted displays (HMDs) (e.g., wearable glasses, head-mounted binoculars, gaming displays, military headwear, etc.), and other wearable devices (e.g., smartwatches, bracelets, smartcards, jewelry, clothing items, etc.), and/or the like.

Computing device 100 may include an operating system (OS) 106 serving as an interface between hardware and/or physical resources of the computer device 100 and a user. Computing device 100 further includes one or more processor(s) 102, memory devices 104, network devices, drivers, or the like, as well as input/output (I/O) sources 108, such as touchscreens, touch panels, touch pads, virtual or regular keyboards, virtual or regular mice, etc.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, “code”, “software code”, and the like, may be used interchangeably throughout this document. Also, terms like “job”, “input”, “request”, “message”, and the like, may be used interchangeably throughout this document. It is contemplated that the term “user” may refer to an individual or a person or a group of individuals or persons using or having access to one or more computing devices, such as computing device 100.

FIG. 2 illustrates voxel mechanism 110 of FIG. 1 according to one embodiment. In one embodiment, voxel mechanism 110 may include any number and type of components, such as (without limitation): detection/reception logic 201; data and trust evaluation logic (“evaluation logic”) 203; aggregation logic 205; generation logic 207; trust metrics tagging logic (“trust logic”) 209; metadata trust logic 211; filtering logic 213; user interface logic 215; and communication/compatibility logic 217. Computing device 100 is further shown to provide user interface 219 and I/O source(s) 108 including capturing/sensing component(s) 231 and output component(s) 233. Computing device 100 is further illustrated as having access to and being in communication with one or more database(s) 225.

Computing device 100 (e.g., server computer) may be in communication with one or more client computing devices including any communication and/or data processing devices, such as computing device 250 (e.g., client computer), over communication medium(s) 230 (e.g., cloud network, Internet, proximity network, etc.). Computing device 250 is shown as hosting software application 251 offering application programming interface (“API” or “user interface”) 253 and communication/interfacing logic 255. Computing device 250 is further shown as having storage device 259 and one or more I/O component(s) 257, such as camera(s) 261, display screen(s) 269, and/or the like. Computing device 250 may include (without limitation) mobile computers (e.g., smartphone, tablet computers, etc.), smart wearable devices (e.g., smart watch, wearable glasses, HMDs, etc.), Internet of Things (IoT) devices, laptop computers, netbooks, desktop computers, etc.

As aforementioned, computing device 100 may include a server computer (e.g., cloud-based server, application server, Web server, etc.) hosting I/O sources 108 having capturing/sensing components 231 and output sources 233. In one embodiment, capturing/sensing components 231 may include sensor array (such as microphones or microphone array (e.g., ultrasound microphones), cameras or camera array (e.g., two-dimensional (2D) cameras, 3D cameras, infrared (IR) cameras, depth-sensing cameras, etc.), capacitors, radio components, radar components, etc.), scanners, etc., while output components may include display screens/devices, projectors, speakers, etc.

Like I/O source(s) 108 of computing device 100, computing device 250 also includes one or more I/O component(s) 257, such as one or more camera(s) 261 (e.g., 2D/3D cameras, depth-sensing cameras, cameras, infrared (IR) cameras, etc.), capacitors, radio components, radar components, one or more microphones, one or more sensors, scanners, accelerometers, light-emitting diodes (LEDs), one or more speakers and/or vibration motors, projectors, display screens 267, etc.). Computing device 250 is further shown to include storage medium or device 259 and host client-side software application, such as software application 251, offering user interface 253 (e.g., graphical user interface (GUI)-based user interface, such as a Web browser, mobile application-based user interface, etc.) and having communication/interface logic 255 to facilitate user interface 253 and communication with other devices including other computing devices, such as computing device 100.

Further, in one embodiment, voxel mechanism 110 may be hosted entirely by a server computer, such as computing device 100, or, in another embodiment, one or more components of voxel mechanism 110 may be hosted by a client computer, such as computing device 250. For example, software application 251 at computing device 250 may be a client-based software application complimenting voxel mechanism 110 at computing device 100, where, for example, user interface logic 215 may offer user interface 219 at computing device 100 and, in some embodiments, also offer user interface 253 of software application 251 as further facilitated by communication/interfacing logic 255.

As aforementioned, computing device 100 may be further in communication with one or more repositories, data sources, databases, such as database(s) 225, having any amount and type of information, such as data, metadata, etc., relating to any number and type of applications, such as world views or images, data/metadata relating to geographical locations and/or images sources (e.g., cameras, satellites, etc.), trust metrics, trust metrics metadata, security data, user preferences and/or profiles, and/or the like. Further, data and/or metadata may be related to a particular object, such as a 3D model of a building, an automobile, a table, etc., where a 3D model may be generated from blueprint/engineering sources and thus contain high level of details and serve as ground truth, as opposed to merely a “recorded” model.

Embodiments provide for a novel technique for representing objects (e.g., 2D objects, 3D objects) in a space as voxels, which is a distinct representation of filled space as opposed to conventional representations, such as a mesh representation that defines spaces using points and surfaces, where a voxel representation of objects may be used for any number and type of software applications, such as computer vision, augmented reality (AR), space navigation, collision detection, any analysis of a space filled with solid objects, and/or the like. A voxel refers to a hierarchical data structure that is capable of aggregating data points contained in 3D space. For example, a voxel tree may be used for visualization in several “resolution layers” because at a higher level, all data points contained in a voxel may be merged to an average of the contained data points. Voxels may of any size and contain finer granularity voxels inside that can be visualized at a deeper level or resolution. This technique allows for efficient space storage and access.

In one embodiment, voxels represent or include 3D pixels (e.g., small shapes, typically cubes or cubular in shape) that are used to model objects (e.g., physical 3D objects, such as cars, buildings, persons, etc.) in space. Conventional techniques try to model the world as full of objects that are identified and represented with meshes being points and surfaces in space. Object identification and mesh creation from images are cumbersome and inefficient.

Embodiments provide for creating a voxel model that is easier to perform even from multiple views as provided by multiple sources 271. This technique provides for the creation of a world model more tractable and since this type of model is of a physical space occupied by an object, any need for changing classifications or multiple interpretations is eliminated. In one embodiment, a centralized model of the real world may be built using publically available images (e.g., source 271N, from websites and/or applications) as well as images from dedicated sources (such as public/private cameras, satellites, etc.) to create a real-time updated physical representation of the world in voxels.

For example, voxel representations are superior to and distinct from mesh representations in that a voxel representation is far easier in combining or merging collections of voxels to create a combined view of a space, as facilitated by aggregation logic 205 and generation logic 207. For example, consider a city street scene modeled with voxels, where the scene includes any number and type of objects, such as cars, road surfaces, signs, buildings, etc., represented by voxels. A voxel representation, such as of a city street scene including various objects, may be generated by obtaining any relevant images from any number and type of origins or sources, such as data sources 271. For instance, a representation of road surfaces and/or signs may be created by using images provided by one or more of government source(s) 271B, 271C (e.g., images obtained using government-run street/traffic cameras, government employees' surveying cameras, government satellites, etc.), while any representation of cars, homes, etc., may be generated using personal source(s) 271A or private and/or commercial source(s) 271D, 271D, such as personal user cameras, private commercial cameras installed for security or mapping reasons, private commercial satellites, etc., according to, for example, user-specified trust preferences through user interface 253 at computing device 250. Other data sources 271 may include any number and type of dedicated sites or repositories, such as websites and other software applications 271N, database(s) 225, etc.

In one embodiment, based one any amount and type of information, such as data, metadata, etc., relating to one or more of source(s) 271, trust metrics, as facilitated by trust logic 209, may be introduced to offer a check on the veracity of each voxel representation offer to the user to be viewed through user interface 253 (e.g., web browser, application-specific interface, etc.) at computing device 250. For example, as will be further described in this document with regard to trust logic 209, metadata trust logic 211, and filtering logic 213, by tagging individual voxels within a representation with trust metrics indicating trust or reliability of a corresponding origin or source, such as one of source(s) 271, a level of control is offered to the user having access to computing device 250 to view, verify, decide, etc., the veracity of each voxel in a voxel representation based on any number and type of factors relating to individuals, groups, organizations, entities, locations, distances, timespans, historical data, current data, public or private metadata, quality or systems of capturing and/or computing devices, etc., associated with each of source(s) 271.

It is contemplated that conventional techniques rely on a single source for images. Embodiments provide for receiving and aggregating images and/or other relevant information from multiple data sources, such as sources 271, to generate voxel-based real world or virtual world representations. For instance, an augmented reality view or a street scene may be created from images of road surfaces from local government sources and other images from individuals, companies, etc., using personal cameras, commercials cameras, etc., around the street. In one embodiment, processing part for reconstructing a scene may be abstracted to adapt to variable requirements on an application display side, enabling multi-source data generation as well as scene reconstructions.

In one embodiment, one or more images or video streams of a scene of a physical location or a geographical location, such as a residential street or a commercial shopping mall, respectively, which are then aggregated to form a voxel representation of the location, may be obtained from one or more data source(s) 271, such as (without limitation): personal/user camera(s) 271A (e.g., still cameras and/or moving cameras, such as neighborhood watch cameras, users' personal cameras, such as smartphone cameras, etc.); government/public camera(s) 271B (e.g., closed circuit cameras, traffic cameras, etc.); government satellite(s) 271C (e.g., information/spying satellites, military satellites, exploration/educational satellites, etc.); private/commercial camera(s) 271D (e.g., television cameras, news reporter cameras, gaming and/or AR company cameras, profit/non-profit organization cameras, educational institution cameras, etc.); private/commercial satellite(s) 271E (e.g., television broadcasting satellites, corporation satellites, gaming and/or AR company satellites, profit/non-profit organization satellites, educational institution satellites, etc.); websites and/or other software applications 271N (such as mapping websites (e.g., Google® Maps®, Google® Earth®, etc.), social networking websites (e.g., Facebook®, Twitter®, etc.), business or commercial websites (e.g., real estate listing website (e.g., Zillow.com®), company website, etc.), personal websites, gaming applications, etc.); and/or the like.

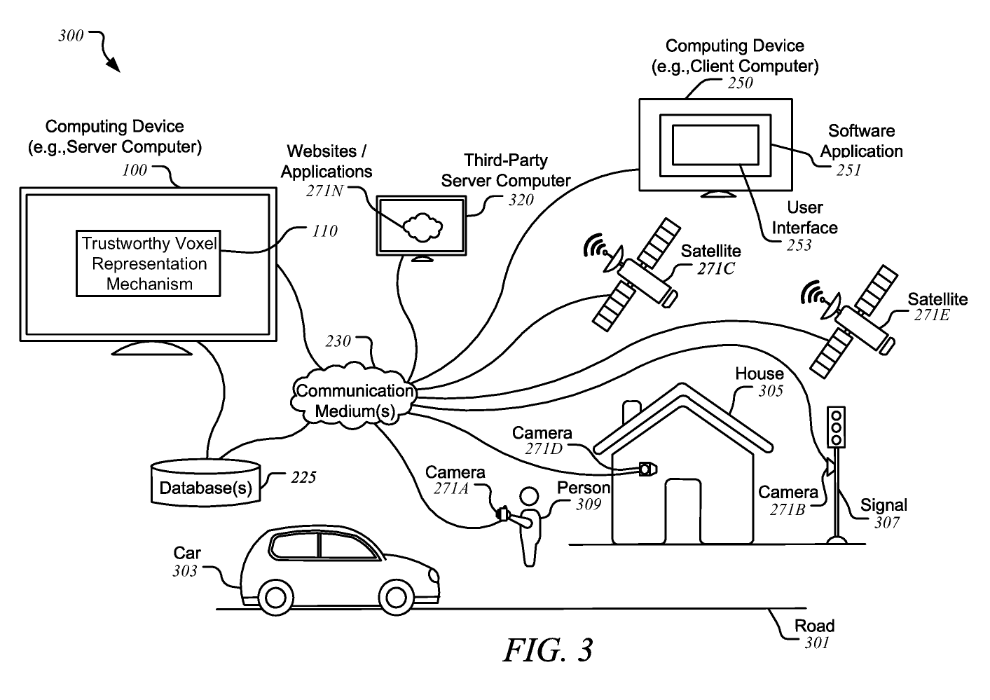

It is contemplated that embodiments are not merely limited to voxel representations relating to images of any number and type of physical or geographic locations, and/or whether such locations be interior or exterior locations, and/or any number and type of sources or original devices for capturing images, and/or any number and type of users, and/or the like. However, for the sake of brevity and clarity, street images, such as the one illustrated with reference to FIG. 3, and various data sources, such as data source(s) 271, are discussed as examples throughout this document but that it is to be noted that embodiments are not limited as such. It is contemplated that term “image” as referenced throughout this document may include (without limitations) a still image, a video stream, an animation, a graphical representation, and/or the like.

In one embodiment, detection/reception logic 201 may be used to detect or receive any number and type of images of, for example, a street scene from one or more data source(s) 271 over one or more networks, such as communication medium(s) 230. Upon receiving the images from data source(s) 271, evaluation logic 203 may then be triggered to evaluate each image to determine its quality, placement, authenticity, reliability, dependency, credibility, etc., along with its trust level by evaluating its source(s) 271. For example, it is contemplated that in some cases, an image received from personal/user camera(s) 271A may be regarded as more trustworthy then an image provided by government satellite(s) 271C as, for any number of reasons, a government-provided image may not be entirely free of a political agenda. Such criteria, for example, may be even more prevalent in certain countries or parts of a country if there is constant history to indicate mistrust of the government due to misuse of power, human rights abuses, or on-going events (e.g., war, revolution, etc.), etc., as gathered and provided by metadata trust logic 211 and stored at database(s) 225. Stated differently, in this case the trust factor is based on administrators (e.g., users or individuals, businesses, companies, organizations, entities, institutions, etc., serving as proprietors, controllers, managers, etc.), of one or more data source(s) 271, such as data source(s) 271A and 271C, to evaluate and determine the veracity of their images.

Similarly, in some embodiments, various characteristics (such as quality, age, sophistication, power, history, etc.) relating to actual image capturing devices (e.g., 2D cameras, 3D cameras, depth-sensing cameras, etc.) and/or associated or coupled devices (e.g., computing devices, satellites, etc.) associated with data source(s) 271 may be taken into consideration instead of or in addition to one or more other factors, such as the aforementioned factor of trustworthiness or credibility, etc., of the administrators and/or organizations associated with source(s) 271. For example, in some embodiments, an image offered by one or more source(s) 271 associated with a government, a company, etc., may be regarded as more trustworthy than an image taken by a bystander because, for instance, government/public camera(s) 271B, government satellite(s) 271C, etc., may be regarded as better image-capturing devices (such as in terms of power, accuracy, timeliness, etc.) than personal/user camera(s) 271A (e.g., smartphone-based camera) belonging to the bystander. Similarly, images obtained from a company's website, such as website(s) 271N, may be regarded as high in trustworthiness if, for instance, the company is known for employing state-of-the-art camera(s) 271D, satellite(s) 271E, etc., for their business (e.g., online street maps, online real-estate listings, etc.).

As aforementioned, multiple factors may be taken into consideration, such as administrator reputation and device characteristics, where evaluation logic 203 may simultaneously consider such multiple factors to determine trustworthiness of images, such as in some embodiments, even with excellent reputation for camera(s) 271B, 271D and satellite(s) 271C, 271E, certain governments and/or companies may not be regarded high on trust and in such cases, the administrator's reputation may outweigh the corresponding device's characteristics, while, in other embodiments, a device's characteristics may outweigh it's administrator's reputation.

In one embodiment, other trust factors may include (without limitations) one or more of image timing (e.g., a more recent image may be regarded as more relevant and/or better than an older image or vice versa, a daytime image may be regarded as more relevant and/or better than a nighttime image or vice versa, etc.), image clarity (e.g., clearer/sharper image may be regarded as more relevant and/or better than a foggier image or vice versa), image distance (e.g., a closer image may be regarded as more relevant and/or better than a distant image or vice versa), image quantity (e.g., multiple images of an object may be regarded as more relevant and/or better than a single or fewer images of the same object or vice versa), and/or the like. Embodiments are not limited to any particular number and/or type of trust factors and that any number and type of other trust factors that are not listed or discussed in this document are also equally contemplated.

In embodiment, detection/reception logic 201 may continuously, periodically, and/or on-demand receive updated data, newsfeeds, historical updates, etc., regarding each of source(s) 271 and their associated administrators, capturing devices, etc., and communicate this information on to metadata trust logic 211 while storing the information at database(s) 225. In one embodiment, metadata trust logic 211 may receive or access any relevant set of data regarding any of source(s) 271 and provide this set of data to evaluation logic 203 so that it may be taken into consideration at trust evaluation stage. For example, evaluation logic 203 may alter its findings regarding a level of trust to be assigned to an image based on any new data received from metadata trust logic 211.

In one embodiment, upon evaluation of images, trust logic 209 may then assign a trust metric to each image of the images received from one or more of source(s) 271 based on results of evaluation performed by evaluation logic 203. In one embodiment, the trust metric may indicate a trust level of the image to which it is assigned, where a trust metric may be a number, an alphabet, a character, a word, and/or the like. For example, a trust level of 1 may be considered a lowest level of trust, while a trust level of 10 may be regarded as a highest level of trust or vice versa. Similarly, trust metrics may include alphabets (e.g., A being highest, D being lowest, etc.), characters (e.g., smile face being highest, frown fact being lowest, etc.), words or phrases (e.g., pass being highest, fail being lowest, etc.), and/or the like, to indicate trust levels of their respective images.

In one embodiment, veracity of voxel representations for offering real-world and/or virtual-world representations is checked by assigning or tagging trust metrics to each data sources, such as source(s) 271, contained in a voxel tree structure voxel that is part of some object representation. For example, a trust metric may be assigned by a space combination application, such as trust logic 209, that uses knowledge of a relevant source of source(s) 271 relating to a particular voxel to compute a trust metric for ensuring the veracity of the voxel for a specific software application, such as software application 251, used for augmented reality tasks, mapping tasks, gaming tasks, etc.

In some embodiments, there may be multiple trust metrics depending on the usage by a particular software application, such as software application 251. For instance, a trust metric for computing collision threat between objects (e.g., cars) may be different from another trust metric that is determined for computing render quality of an object for subsequent frames. This novel flexible technique allows for an encoder to spend more of its data bandwidth on interesting dynamic objects in a scene to make the entire scene better represented for any particular bandwidth. This further allows for servicing various differing experiences based on user-defined parameters (e.g., render a view of this building from sources coming from government sources versus render a view of this building from all public sources during the last two hours, etc.) as provided by the user in user profiles and/or preferences using user interface 253.

Upon assigning trust metrics to the respective images, such images may then be aggregated, by aggregation logic 205, into a common or single representation, such as a street scene and its various objects. In one embodiment, generation logic 207 may then be triggered to generate a voxel representation from this aggregated representation, where this voxel representation may then be communicated, as facilitated by communication/compatibility logic 217, onto one or more software applications, such as software application 251, at one or more computing devices, such as computing device 250, to facilitate the one or more software applications to use the voxel representation in their respective tasks or services, such as computer vision, augmented reality, 3D games, space navigation, street or world mapping, collection detection between objects, national defense tasks, scientific research, archeological exploration, geological analysis, and any analysis of a space filled with solid objects, and/or the like.

As illustrated, voxel mechanism 110 further includes filtering logic 213 that may be triggered at any point during processing of images, such as prior to aggregation or even after having formed a voxel representation to filter out any images or relevant details from the voxel representation being communicated to computing device 250. For example, in some embodiment, multiple images of a single location may received from a single or multiple sources of data source(s) 271, which may lead filtering logic 213 to filter out the additional images and leave a single image that is regarded as the best or one of the best per evaluation by evaluation logic 203. Similarly, in some embodiments, any details which may be regarded as one or more of (without limitations) obscene, illegal, unethical, irrelevant, unwanted, duplicated, etc., based any one or more of (without limitations) relevant laws, rules, regulations, bylaws, moral standards, ethical values, user preferences and/or profiles, etc., may be filtered out from being included in the voxel representation to be communicated to computing device 250 for viewing my one or more users having access to the computing device 250 and/or one or more other computing devices in communication with computing device 250.

Referring now to software application 251 at computing device 250, communication/interface logic 255 may receive a voxel representation from communication/compatibility logic 217 of voxel mechanism 110 at computing device 100 over one or more communication medium(s) 230, where the voxel representation may then be provided to the user for viewing through user interface 253 at computing device 250. In one embodiment, the user having access to computing device 250 may be able to view the voxel representation using user interface 253.

In one embodiment, the user may be offered control over trustworthiness of various images of objects associated with voxel representation such that the user may choose to include or remove any number and type of portions or images from the voxel representation using user interface 253 as desired or necessitated by the user. In another embodiment, the user may be allowed to set up a profile and/or preferences using user interface 253 at computing device 250, where the profile and/or preferences to indicate any range of images, sources, etc., that are regarded as trustworthy or untrustworthy by the user. Such profile and/or preferences may be communicated back to voxel mechanism 110 where user indications are noted by metadata trust logic 211, taken into account by evaluation logic 203, deliberated by filtering logic 213, and/or considered by trust logic 209, such as when tagging (or not tagging) trust metrics to various images and/or portions of voxel representations, before any voxel representations are communicated over to computing device 250 for viewing and use by the user.

Capturing/sensing components 231 at computing device 100 and/or I/O component(s) 257 at computing device 250 may further include one or more of vibration components, tactile components, conductance elements, biometric sensors, chemical detectors, signal detectors, electroencephalography, functional near-infrared spectroscopy, wave detectors, force sensors (e.g., accelerometers), illuminators, eye-tracking or gaze-tracking system, head-tracking system, etc., that may be used for capturing any amount and type of visual data, such as images (e.g., photos, videos, movies, audio/video streams, etc.), and non-visual data, such as audio streams or signals (e.g., sound, noise, vibration, ultrasound, etc.), radio waves (e.g., wireless signals, such as wireless signals having data, metadata, signs, etc.), chemical changes or properties (e.g., humidity, body temperature, etc.), biometric readings (e.g., figure prints, etc.), brainwaves, brain circulation, environmental/weather conditions, maps, etc. It is contemplated that “sensor” and “detector” may be referenced interchangeably throughout this document. It is further contemplated that one or more capturing/sensing component(s) 231 and/or I/O component(s) 257 may further include one or more of supporting or supplemental devices for capturing and/or sensing of data, such as illuminators (e.g., IR illuminator), light fixtures, generators, sound blockers, etc.

It is further contemplated that in one embodiment, capturing/sensing component(s) 231 and/or I/O component(s) 257 may further include any number and type of context sensors (e.g., linear accelerometer) for sensing or detecting any number and type of contexts (e.g., estimating horizon, linear acceleration, etc., relating to a mobile computing device, etc.). For example, capturing/sensing component(s) 231 and/or I/O component(s) 257 may include any number and type of sensors, such as (without limitations): accelerometers (e.g., linear accelerometer to measure linear acceleration, etc.); inertial devices (e.g., inertial accelerometers, inertial gyroscopes, micro-electro-mechanical systems (MEMS) gyroscopes, inertial navigators, etc.); and gravity gradiometers to study and measure variations in gravitation acceleration due to gravity, etc.

Further, for example, capturing/sensing component(s) 231 and/or I/O component(s) 257 may include (without limitations): audio/visual devices (e.g., cameras, microphones, speakers, etc.); context-aware sensors (e.g., temperature sensors, facial expression and feature measurement sensors working with one or more cameras of audio/visual devices, environment sensors (such as to sense background colors, lights, etc.); biometric sensors (such as to detect fingerprints, etc.), calendar maintenance and reading device), etc.; global positioning system (GPS) sensors; resource requestor; and/or TEE logic. TEE logic may be employed separately or be part of resource requestor and/or an I/O subsystem, etc. Capturing/sensing component(s) 231 and/or I/O component(s) 257 may further include voice recognition devices, photo recognition devices, facial and other body recognition components, voice-to-text conversion components, etc.

Similarly, output component(s) 233 and/or I/O component(s) 257 may include dynamic tactile touch screens having tactile effectors as an example of presenting visualization of touch, where an embodiment of such may be ultrasonic generators that can send signals in space which, when reaching, for example, human fingers can cause tactile sensation or like feeling on the fingers. Further, for example and in one embodiment, output component(s) 233 and/or I/O component(s) 257 may include (without limitation) one or more of light sources, display devices and/or screens, audio speakers, tactile components, conductance elements, bone conducting speakers, olfactory or smell visual and/or non/visual presentation devices, haptic or touch visual and/or non-visual presentation devices, animation display devices, biometric display devices, X-ray display devices, high-resolution displays, high-dynamic range displays, multi-view displays, and head-mounted displays (HMDs) for at least one of virtual reality (VR) and augmented reality (AR), etc.

It is contemplated that embodiment are not limited to any particular number or type of use-case scenarios; however, for the sake of brevity and clarity, one or more use-case scenarios, such as the one illustrated with respect FIG. 3, are discussed throughout this document for exemplary purposes but that embodiments are not limited as such. Further, throughout this document, “user” may refer to someone having access to one or more computing devices, such as computing device 250, and may be referenced interchangeably with “person”, “individual”, “human”, “him”, “her”, “child”, “adult”, “viewer”, “player”, “gamer”, “developer”, programmer”, and/or the like.

Communication/compatibility logic 217 may be used to facilitate dynamic communication and compatibility between various components, networks, computing devices, etc., such as server computer 100, client computer 250, data source(s) 271, etc., database(s) 225, and/or communication medium(s) 230, etc., and any number and type of other computing devices (such as wearable computing devices, mobile computing devices, desktop computers, server computing devices, etc.), processing devices (e.g., central processing unit (CPU), graphics processing unit (GPU), etc.), capturing/sensing components (e.g., non-visual data sensors/detectors, such as audio sensors, olfactory sensors, haptic sensors, signal sensors, vibration sensors, chemicals detectors, radio wave detectors, force sensors, weather/temperature sensors, body/biometric sensors, scanners, etc., and visual data sensors/detectors, such as cameras, etc.), user/context-awareness components and/or identification/verification sensors/devices (such as biometric sensors/detectors, scanners, etc.), memory or storage devices, data sources, and/or database(s) (such as data storage devices, hard drives, solid-state drives, hard disks, memory cards or devices, memory circuits, etc.), network(s) (e.g., Cloud network, Internet, Internet of Things, intranet, cellular network, proximity networks, such as Bluetooth, Bluetooth low energy (BLE), Bluetooth Smart, Wi-Fi proximity, Radio Frequency Identification, Near Field Communication, Body Area Network, etc.), wireless or wired communications and relevant protocols (e.g., Wi-Fi®, WiMAX, Ethernet, etc.), connectivity and location management techniques, software applications/websites, (e.g., social and/or business networking websites, business applications, games and other entertainment applications, etc.), programming languages, etc., while ensuring compatibility with changing technologies, parameters, protocols, standards, etc.

Throughout this document, terms like “logic”, “component”, “module”, “framework”, “engine”, “tool”, and/or the like, may be referenced interchangeably and include, by way of example, software, hardware, and/or any combination of software and hardware, such as firmware. In one example, “logic” may refer to or include a software component that is capable of working with one or more of an operating system, a graphics driver, etc., of a computing device, such as computing device 100, 250. In another example, “logic” may refer to or include a hardware component that is capable of being physically installed along with or as part of one or more system hardware elements, such as an application processor, a graphics processor, etc., of a computing device, such as computing device 100, 250. In yet another embodiment, “logic” may refer to or include a firmware component that is capable of being part of system firmware, such as firmware of an application processor or a graphics processor, etc., of a computing device, such as computing device 100, 250.

Further, any use of a particular brand, word, term, phrase, name, and/or acronym, such as “voxel”, “voxel representation”, “image”, “video stream”, “animation”, “graphical representation”, “source”, “origin”, “aggregation of images”, “trust metric”, “trust level”, “trustworthiness”, “tagging”, “trust metadata”, “filtering”, “user interface”, “camera”, “sensor”, “microphone”, “display screen”, “speaker”, “recognition”, “authentication”, “privacy”, “user”, “user profile”, “user preference”, “sender”, “receiver”, “personal device”, “smart device”, “mobile computer”, “wearable device”, “IoT device”, “proximity network”, “cloud network”, “server computer”, etc., should not be read to limit embodiments to software or devices that carry that label in products or in literature external to this document.

It is contemplated that any number and type of components may be added to and/or removed from voxel mechanism 110 to facilitate various embodiments including adding, removing, and/or enhancing certain features. For brevity, clarity, and ease of understanding of voxel mechanism 110, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

FIG. 3 illustrates a use-case scenario 300 according to one embodiment. As an initial matter, for brevity, many of the details discussed with reference to the previous FIGS. 1-2 may not be discussed or repeated hereafter. Further, it is contemplated and to be noted that embodiments are not limited to any particular number or type of architectural placements, component setups, processes, and/or use-case scenarios, etc., such as use-case scenarios 300.

In the illustrated embodiment, use-case scenario 300 includes a street view having one or more physical 3D objects, such as road 301, car 303 on road 301, house 305 by the side of road 301, person 309, signal light 307, etc. In light of the above discussion with respect to FIG. 2, a number of image capturing devices, such as cameras, are also shown being placed at various points within use-case scenario 300. For example, as discussed with reference to FIG. 2, in one embodiment, one or more cameras capable of being used for taking images (e.g., still images, video streams, etc.) may be more intimate or immediate to the ground scene as being installed on or held by one or more objects, such as personal/user camera(s) 271A is shown as being held by person 309, private/commercial camera(s) 271D shown as installed on house 305, while government/public camera(s) 271B is shown as being installed on signal light 307.

Similarly, in another embodiment, other forms of image capturing devices (e.g., cameras) are shown as being more remote to the scene on the ground, such as images (e.g., still images, video streams, etc.) may be taken using various cameras associated with government satellite(s) 271C, private/commercial satellite(s) 271E, etc.

As further discussed with reference to FIG. 2, in yet another embodiment, images and/or other information may be obtained from any number and type of other sources, such as sources other than directly from image capturing devices, such as websites and/or other applications 271N (e.g., street maps website, global maps website, social networking applications, real estate listing websites, government websites, etc.), and/or the like, being offered by a third-party vendor through their server computer, such as third-party server computer 320, over communication medium(s) 230, such as cloud network, Internet, etc. In yet another embodiment, images and/or other information may be obtain by simply accessing one or more repositories, such as database(s) 225, having stored thereon such images and/or other information.

As illustrated, in one embodiment, images and/or other information from various data sources, such as source(s) 271A, 271B, 271C, 271D, 271E, and 271N, may be received by voxel mechanism 110 at computing device 100 (e.g., server computer), where voxel representation are generated by voxel mechanism 110 using the images and/or other information and such voxel representations are then selectively forwarded to one or more computing devices, such as computing device 250 (e.g., client computer), over communication medium(s) 230, for viewing by one or more users having access to user interface 253 of software application 251 at computing device 250.

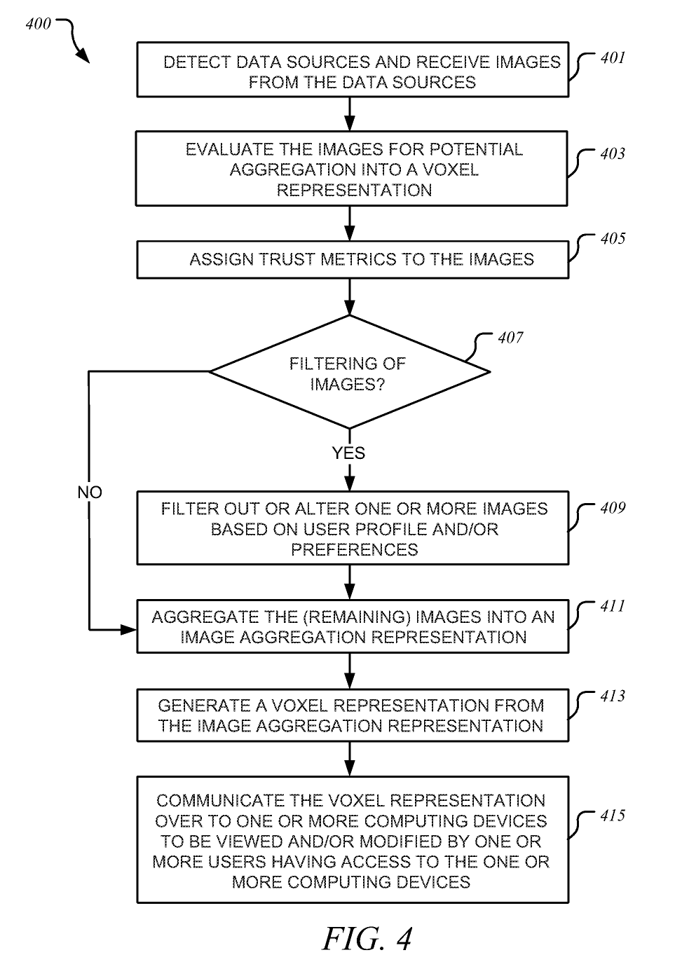

FIG. 4 illustrates a method 400 for facilitating generation and safeguarding veracity of voxel representations according to one embodiment. Method 400 may be performed by processing logic that may comprise hardware (e.g., circuitry, dedicated logic, programmable logic, etc.), software (such as instructions run on a processing device), or a combination thereof, as facilitated by voxel mechanism 110 of FIG. 1. The processes of method 400 are illustrated in linear sequences for brevity and clarity in presentation; however, it is contemplated that any number of them can be performed in parallel, asynchronously, or in different orders. For brevity, many of the details discussed with reference to the previous FIGS. 1-3 may not be discussed or repeated hereafter.

Method 400 begins at block 401 with detection of data sources (such as data source(s) 271 of FIG. 2) and receiving of images and/or any other relevant information relating to scene (e.g., physical location having objects, such as a street, a city, an event, the globe, etc.) from the data sources over one or more communication mediums, such as a cloud network, a proximity network, the Internet, etc. At block 403, the images are evaluated for potential aggregation into a voxel representation providing real-world and/or virtual-world representation of the scene. In one embodiment, the evaluation includes analysis of each image along with any other relevant information, such as data and/or metadata, relating to the data sources, administrators of the data sources, image capturing devices associated with the data sources, etc., to determine veracity of each of the images.

At block 405, trust metrics are assigned to the images based on results of the evaluation. At block 407, a determination is made as to whether one or more of the images are to be filtered out based on a user profile and/or a set of user preferences associated with a user of a client computer. If yes, the one or more images are filtered out of the images based on the user profile and/or preferences at block 409. At block 411, the (remaining) images are aggregated together into an aggregated representation. At block 413, the aggregated representation is then generated into a voxel representation.

At block 415, the voxel representation is then communicated over to the client computer, where the voxel representation is then offered at the client computer for viewing by the user using a user interface provided by a software application at the client computer. Referring back to block 407, if the filtering of the images is not necessitated, method 400 continues at block 411 with aggregation of the images and then subsequently, at block 413, with generation of the voxel representation and, at block 415, communicating of the voxel image to the client computer.

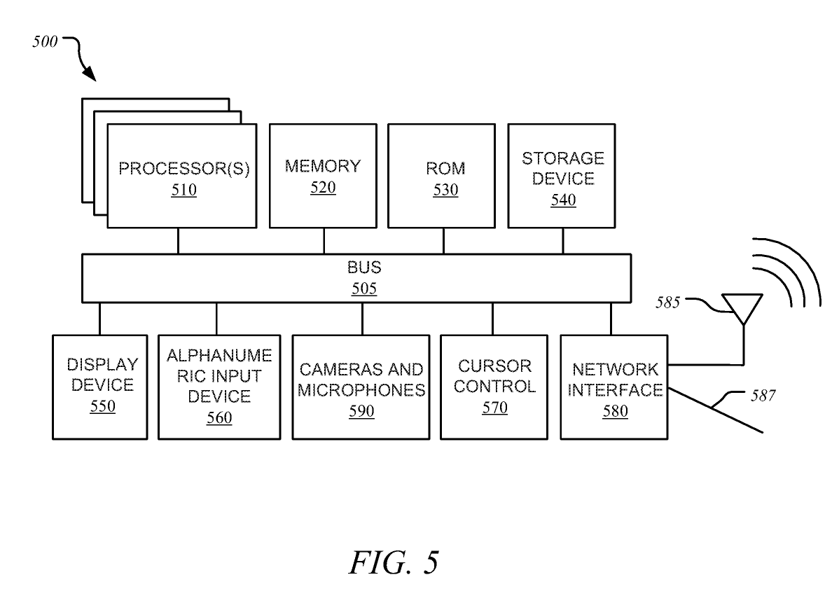

FIG. 5 illustrates an embodiment of a computing system 500 capable of supporting the operations discussed above. Computing system 500 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, wearable devices, etc. Alternate computing systems may include more, fewer and/or different components. Computing device 500 may be the same as or similar to or include computing devices 100 described in reference to FIG. 1.

Computing system 500 includes bus 505 (or, for example, a link, an interconnect, or another type of communication device or interface to communicate information) and processor 510 coupled to bus 505 that may process information. While computing system 500 is illustrated with a single processor, it may include multiple processors and/or co-processors, such as one or more of central processors, image signal processors, graphics processors, and vision processors, etc. Computing system 500 may further include random access memory (RAM) or other dynamic storage device 520 (referred to as main memory), coupled to bus 505 and may store information and instructions that may be executed by processor 510. Main memory 520 may also be used to store temporary variables or other intermediate information during execution of instructions by processor 510.

Computing system 500 may also include read only memory (ROM) and/or other storage device 530 coupled to bus 505 that may store static information and instructions for processor 510. Date storage device 540 may be coupled to bus 505 to store information and instructions. Date storage device 540, such as magnetic disk or optical disc and corresponding drive may be coupled to computing system 500.

Computing system 500 may also be coupled via bus 505 to display device 550, such as a cathode ray tube (CRT), liquid crystal display (LCD) or Organic Light Emitting Diode (OLED) array, to display information to a user. User input device 560, including alphanumeric and other keys, may be coupled to bus 505 to communicate information and command selections to processor 510. Another type of user input device 560 is cursor control 570, such as a mouse, a trackball, a touchscreen, a touchpad, or cursor direction keys to communicate direction information and command selections to processor 510 and to control cursor movement on display 550. Camera and microphone arrays 590 of computer system 500 may be coupled to bus 505 to observe gestures, record audio and video and to receive and transmit visual and audio commands.

Computing system 500 may further include network interface(s) 580 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 580 may include, for example, a wireless network interface having antenna 585, which may represent one or more antenna(e). Network interface(s) 580 may also include, for example, a wired network interface to communicate with remote devices via network cable 587, which may be, for example, an Ethernet cable, a coaxial cable, a fiber optic cable, a serial cable, or a parallel cable.

Network interface(s) 580 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 580 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 580 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 500 may vary from implementation to implementation depending upon numerous factors, such as price constraints, performance requirements, technological improvements, or other circumstances. Examples of the electronic device or computer system 500 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

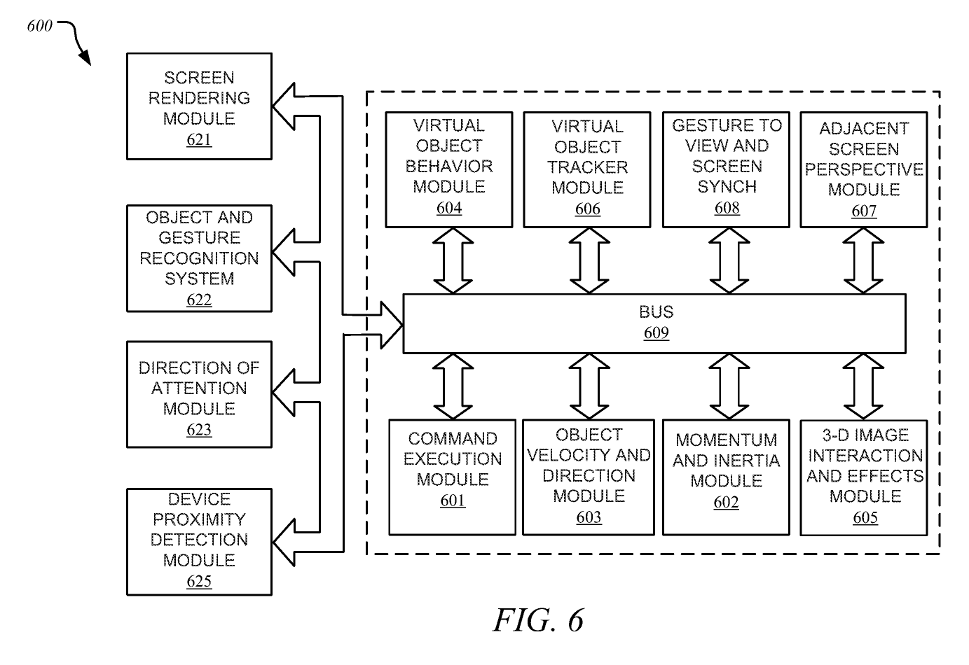

FIG. 6 illustrates an embodiment of a computing environment 600 capable of supporting the operations discussed above. The modules and systems can be implemented in a variety of different hardware architectures and form factors including that shown in FIG. 5.

The Command Execution Module 601 includes a central processing unit to cache and execute commands and to distribute tasks among the other modules and systems shown. It may include an instruction stack, a cache memory to store intermediate and final results, and mass memory to store applications and operating systems. The Command Execution Module may also serve as a central coordination and task allocation unit for the system.

The Screen Rendering Module 621 draws objects on the one or more multiple screens for the user to see. It can be adapted to receive the data from the Virtual Object Behavior Module 604, described below, and to render the virtual object and any other objects and forces on the appropriate screen or screens. Thus, the data from the Virtual Object Behavior Module would determine the position and dynamics of the virtual object and associated gestures, forces and objects, for example, and the Screen Rendering Module would depict the virtual object and associated objects and environment on a screen, accordingly. The Screen Rendering Module could further be adapted to receive data from the Adjacent Screen Perspective Module 607, described below, to either depict a target landing area for the virtual object if the virtual object could be moved to the display of the device with which the Adjacent Screen Perspective Module is associated. Thus, for example, if the virtual object is being moved from a main screen to an auxiliary screen, the Adjacent Screen Perspective Module 2 could send data to the Screen Rendering Module to suggest, for example in shadow form, one or more target landing areas for the virtual object on that track to a user's hand movements or eye movements.

The Object and Gesture Recognition System 622 may be adapted to recognize and track hand and arm gestures of a user. Such a module may be used to recognize hands, fingers, finger gestures, hand movements and a location of hands relative to displays. For example, the Object and Gesture Recognition Module could for example determine that a user made a body part gesture to drop or throw a virtual object onto one or the other of the multiple screens, or that the user made a body part gesture to move the virtual object to a bezel of one or the other of the multiple screens. The Object and Gesture Recognition System may be coupled to a camera or camera array, a microphone or microphone array, a touch screen or touch surface, or a pointing device, or some combination of these items, to detect gestures and commands from the user.

The touch screen or touch surface of the Object and Gesture Recognition System may include a touch screen sensor. Data from the sensor may be fed to hardware, software, firmware or a combination of the same to map the touch gesture of a user's hand on the screen or surface to a corresponding dynamic behavior of a virtual object. The sensor date may be used to momentum and inertia factors to allow a variety of momentum behavior for a virtual object based on input from the user's hand, such as a swipe rate of a user's finger relative to the screen. Pinching gestures may be interpreted as a command to lift a virtual object from the display screen, or to begin generating a virtual binding associated with the virtual object or to zoom in or out on a display. Similar commands may be generated by the Object and Gesture Recognition System using one or more cameras without the benefit of a touch surface.

The Direction of Attention Module 623 may be equipped with cameras or other sensors to track the position or orientation of a user's face or hands. When a gesture or voice command is issued, the system can determine the appropriate screen for the gesture. In one example, a camera is mounted near each display to detect whether the user is facing that display. If so, then the direction of attention module information is provided to the Object and Gesture Recognition Module 622 to ensure that the gestures or commands are associated with the appropriate library for the active display. Similarly, if the user is looking away from all of the screens, then commands can be ignored.

The Device Proximity Detection Module 625 can use proximity sensors, compasses, GPS (global positioning system) receivers, personal area network radios, and other types of sensors, together with triangulation and other techniques to determine the proximity of other devices. Once a nearby device is detected, it can be registered to the system and its type can be determined as an input device or a display device or both. For an input device, received data may then be applied to the Object Gesture and Recognition System 622. For a display device, it may be considered by the Adjacent Screen Perspective Module 607.

The Virtual Object Behavior Module 604 is adapted to receive input from the Object Velocity and Direction Module, and to apply such input to a virtual object being shown in the display. Thus, for example, the Object and Gesture Recognition System would interpret a user gesture and by mapping the captured movements of a user's hand to recognized movements, the Virtual Object Tracker Module would associate the virtual object's position and movements to the movements as recognized by Object and Gesture Recognition System, the Object and Velocity and Direction Module would capture the dynamics of the virtual object's movements, and the Virtual Object Behavior Module would receive the input from the Object and Velocity and Direction Module to generate data that would direct the movements of the virtual object to correspond to the input from the Object and Velocity and Direction Module.

The Virtual Object Tracker Module 606 on the other hand may be adapted to track where a virtual object should be located in three-dimensional space in a vicinity of a display, and which body part of the user is holding the virtual object, based on input from the Object and Gesture Recognition Module. The Virtual Object Tracker Module 606 may for example track a virtual object as it moves across and between screens and track which body part of the user is holding that virtual object. Tracking the body part that is holding the virtual object allows a continuous awareness of the body part's air movements, and thus an eventual awareness as to whether the virtual object has been released onto one or more screens.

The Gesture to View and Screen Synchronization Module 608, receives the selection of the view and screen or both from the Direction of Attention Module 623 and, in some cases, voice commands to determine which view is the active view and which screen is the active screen. It then causes the relevant gesture library to be loaded for the Object and Gesture Recognition System 622. Various views of an application on one or more screens can be associated with alternative gesture libraries or a set of gesture templates for a given view. As an example in FIG. 1A a pinch-release gesture launches a torpedo, but in FIG. 1B, the same gesture launches a depth charge.

The Adjacent Screen Perspective Module 607, which may include or be coupled to the Device Proximity Detection Module 625, may be adapted to determine an angle and position of one display relative to another display. A projected display includes, for example, an image projected onto a wall or screen. The ability to detect a proximity of a nearby screen and a corresponding angle or orientation of a display projected therefrom may for example be accomplished with either an infrared emitter and receiver, or electromagnetic or photo-detection sensing capability. For technologies that allow projected displays with touch input, the incoming video can be analyzed to determine the position of a projected display and to correct for the distortion caused by displaying at an angle. An accelerometer, magnetometer, compass, or camera can be used to determine the angle at which a device is being held while infrared emitters and cameras could allow the orientation of the screen device to be determined in relation to the sensors on an adjacent device. The Adjacent Screen Perspective Module 607 may, in this way, determine coordinates of an adjacent screen relative to its own screen coordinates. Thus, the Adjacent Screen Perspective Module may determine which devices are in proximity to each other, and further potential targets for moving one or more virtual object's across screens. The Adjacent Screen Perspective Module may further allow the position of the screens to be correlated to a model of three-dimensional space representing all of the existing objects and virtual objects.

The Object and Velocity and Direction Module 603 may be adapted to estimate the dynamics of a virtual object being moved, such as its trajectory, velocity (whether linear or angular), momentum (whether linear or angular), etc. by receiving input from the Virtual Object Tracker Module. The Object and Velocity and Direction Module may further be adapted to estimate dynamics of any physics forces, by for example estimating the acceleration, deflection, degree of stretching of a virtual binding, etc. and the dynamic behavior of a virtual object once released by a user's body part. The Object and Velocity and Direction Module may also use image motion, size and angle changes to estimate the velocity of objects, such as the velocity of hands and fingers.

The Momentum and Inertia Module 602 can use image motion, image size, and angle changes of objects in the image plane or in a three-dimensional space to estimate the velocity and direction of objects in the space or on a display. The Momentum and Inertia Module is coupled to the Object and Gesture Recognition System 622 to estimate the velocity of gestures performed by hands, fingers, and other body parts and then to apply those estimates to determine momentum and velocities to virtual objects that are to be affected by the gesture.

The 3D Image Interaction and Effects Module 605 tracks user interaction with 3D images that appear to extend out of one or more screens. The influence of objects in the z-axis (towards and away from the plane of the screen) can be calculated together with the relative influence of these objects upon each other. For example, an object thrown by a user gesture can be influenced by 3D objects in the foreground before the virtual object arrives at the plane of the screen. These objects may change the direction or velocity of the projectile or destroy it entirely. The object can be rendered by the 3D Image Interaction and Effects Module in the foreground on one or more of the displays. As illustrated, various components, such as components 601, 602, 603, 604, 605. 606, 607, and 608 are connected via an interconnect or a bus, such as bus 609.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating hybrid communication according to embodiments and examples described herein.

Some embodiments pertain to Example 1 that includes an apparatus to facilitate generation of voxel representations and assignment of trust metrics for ensuring veracity for use with multiple applications, comprising: detection/reception logic to detect a plurality of data sources hosting image capturing devices capable of capturing images of objects in a space, wherein the detection/reception logic is further to receive the images; trust metrics tagging logic (“trust logic”) to tag trust metrics to the images based on credibility of the plurality of data sources, wherein a trust metrics to indicate veracity of a corresponding image; aggregation logic to aggregate the images into an aggregated image representation; and generation logic to generate a voxel representation of the aggregated image representation such that the images are presented as voxel images, wherein veracities of the voxel images are secured based on tagging of the trust metrics to their corresponding images.

Example 2 includes the subject matter of Example 1, further comprising communication/compatibility logic to communicate the voxel representation to one or more computing devices for viewing by one or more users having access to the one or more computing devices, wherein the voxel representation is communicated over one or more networks including a cloud network, a proximity network, or the Internet, wherein a voxel represents a value on a grid in a three-dimensional (“3D”) space, wherein a voxel image represents the grid.

Example 3 includes the subject matter of Example 1, further comprising data and trust evaluation logic (“evaluation logic”) to determine the trust metrics based on evaluation of information relating to one or more of the images, the image capturing devices, the plurality of data sources, and administrators associated with the plurality of data sources, wherein the veracities indicate trustworthiness of the voxel images.

Example 4 includes the subject matter of Example 3, wherein the information comprises data or metadata indicating the credibility of one or more of the images, the images capturing devices, the plurality of data sources, and the administrators associated with the plurality of data sources, wherein the credibility reflects one or more of reliability, dependability, consistency, and quality of one or more of the images, the images capturing devices, the plurality of data sources, and the administrators associated with the plurality of data sources.

Example 5 includes the subject matter of Example 3, further comprising metadata trust logic to receive and maintain the information based on one or more of real-time correspondence, live broadcasts, historical patterns, changing arrangements, environmental considerations, political situations, and geographical contemplations.

Example 6 includes the subject matter of Example 1, further comprising filtering logic to filter out or alter one or more images from the aggregated image representation prior to generation of the voxel representation, wherein the one or more images are filtered out or altered based on a user profile or a set of user preferences associated with a user having access to a computing device of the one or more computing devices.

Example 7 includes the subject matter of Example 6, further comprising: user interface logic to offer a user interface at the computing device such that the voxel representation is capable of being accessed, viewed, and modified via the user interface at the computing device, wherein the voxel representation is capable of being applied to a software application at the computing device, wherein the software application relates to one or more of 3D gaming, computer vision, augmented reality, space navigation, mapping, objects collection detection, national defense tasks, scientific research, archeological exploration, geological analysis, and analysis of spaces filled with solid objects.

Example 8 includes the subject matter of Example 1, wherein the plurality of data sources comprise one or more of government data sources, commercial data sources, and private or organizational data sources, wherein the government data sources include government-administered satellites, other physical entities, websites or other software applications, wherein the commercial data sources include business-administered satellites, other physical entities, websites or other software applications, and wherein the private data sources includes still or movable personal image capturing devices, other physical entities, websites or other software applications.

Example 9 includes the subject matter of Example 1, wherein the image capturing devices comprise one or more of two-dimensional (2D) cameras, 3D cameras, infrared cameras, and depth-sensing cameras, wherein the images comprise one or more of photographs, video streams, animations, and graphical representations, wherein the objects comprise one or more 3D physical objects, and wherein the space comprises a physical area or range.

Some embodiments pertain to Example 10 that includes a method for facilitating generation of voxel representations and assignment of trust metrics for ensuring veracity for use with multiple applications, comprising: detecting, by a computing device, a plurality of data sources hosting image capturing devices capable of capturing images of objects in a space, wherein the images are capable of being received by the computing device; tagging trust metrics to the images based on credibility of the plurality of data sources, wherein a trust metrics to indicate veracity of a corresponding image; aggregating the images into an aggregated image representation; and generating a voxel representation of the aggregated image representation such that the images are presented as voxel images, wherein veracities of the voxel images are secured based on tagging of the trust metrics to their corresponding images.

Example 11 includes the subject matter of Example 10, further comprising: communicating the voxel representation to one or more computing devices for viewing by one or more users having access to the one or more computing devices, wherein the voxel representation is communicated over one or more networks including a cloud network, a proximity network, or the Internet, wherein a voxel represents a value on a grid in a three-dimensional (“3D”) space, wherein a voxel image represents the grid.

Example 12 includes the subject matter of Example 10, further comprising: determining the trust metrics based on evaluation of information relating to one or more of the images, the image capturing devices, the plurality of data sources, and administrators associated with the plurality of data sources, wherein the veracities indicate trustworthiness of the voxel images.

Example 13 includes the subject matter of Example 12, wherein the information comprises data or metadata indicating the credibility of one or more of the images, the images capturing devices, the plurality of data sources, and the administrators associated with the plurality of data sources, wherein the credibility reflects one or more of reliability, dependability, consistency, and quality of one or more of the images, the images capturing devices, the plurality of data sources, and the administrators associated with the plurality of data sources.

Example 14 includes the subject matter of Example 12, further comprising: receiving and maintaining the information based on one or more of real-time correspondence, live broadcasts, historical patterns, changing arrangements, environmental considerations, political situations, and geographical contemplations.

Example 15 includes the subject matter of Example 10, further comprising: filtering out or altering one or more images from the aggregated image representation prior to generation of the voxel representation, wherein the one or more images are filtered out or altered based on a user profile or a set of user preferences associated with a user having access to a computing device of the one or more computing devices.

Example 16 includes the subject matter of Example 15, further comprising: offering a user interface at the computing device such that the voxel representation is capable of being accessed, viewed, and modified via the user interface at the computing device, wherein the voxel representation is capable of being applied to a software application at the computing device, wherein the software application relates to one or more of 3D gaming, computer vision, augmented reality, space navigation, mapping, objects collection detection, national defense tasks, scientific research, archeological exploration, geological analysis, and analysis of spaces filled with solid objects.

Example 17 includes the subject matter of Example 10, wherein the plurality of data sources comprise one or more of government data sources, commercial data sources, and private or organizational data sources, wherein the government data sources include government-administered satellites, other physical entities, websites or other software applications, wherein the commercial data sources include business-administered satellites, other physical entities, websites or other software applications, and wherein the private data sources includes still or movable personal image capturing devices, other physical entities, websites or other software applications.

Example 18 includes the subject matter of Example 10, wherein the image capturing devices comprise one or more of two-dimensional (2D) cameras, 3D cameras, infrared cameras, and depth-sensing cameras, wherein the images comprise one or more of photographs, video streams, animations, and graphical representations, wherein the objects comprise one or more 3D physical objects, and wherein the space comprises a physical area or range.

Some embodiments pertain to Example 19 includes a system comprising a storage device having instructions, and a processor to execute the instructions to facilitate a mechanism to: detect, by a computing device, a plurality of data sources hosting image capturing devices capable of capturing images of objects in a space, wherein the images are capable of being received by the computing device; tag trust metrics to the images based on credibility of the plurality of data sources, wherein a trust metrics to indicate veracity of a corresponding image; aggregate the images into an aggregated image representation; and generate a voxel representation of the aggregated image representation such that the images are presented as voxel images, wherein veracities of the voxel images are secured based on tagging of the trust metrics to their corresponding images.

Example 20 includes the subject matter of Example 19, wherein the mechanism is further to: communicate the voxel representation to one or more computing devices for viewing by one or more users having access to the one or more computing devices, wherein the voxel representation is communicated over one or more networks including a cloud network, a proximity network, or the Internet, wherein a voxel represents a value on a grid in a three-dimensional (“3D”) space, wherein a voxel image represents the grid.

Example 21 includes the subject matter of Example 19, wherein the mechanism is further to: determine the trust metrics based on evaluation of information relating to one or more of the images, the image capturing devices, the plurality of data sources, and administrators associated with the plurality of data sources, wherein the veracities indicate trustworthiness of the voxel images.

Example 22 includes the subject matter of Example 21, wherein the information comprises data or metadata indicating the credibility of one or more of the images, the images capturing devices, the plurality of data sources, and the administrators associated with the plurality of data sources, wherein the credibility reflects one or more of reliability, dependability, consistency, and quality of one or more of the images, the images capturing devices, the plurality of data sources, and the administrators associated with the plurality of data sources.

Example 23 includes the subject matter of Example 22, wherein the mechanism is further to: receive and maintain the information based on one or more of real-time correspondence, live broadcasts, historical patterns, changing arrangements, environmental considerations, political situations, and geographical contemplations.

Example 24 includes the subject matter of Example 19, wherein the mechanism is further to: filter out or alter one or more images from the aggregated image representation prior to generation of the voxel representation, wherein the one or more images are filtered out or altered based on a user profile or a set of user preferences associated with a user having access to a computing device of the one or more computing devices.

Example 25 includes the subject matter of Example 24, wherein the mechanism is further to: offer a user interface at the computing device such that the voxel representation is capable of being accessed, viewed, and modified via the user interface at the computing device, wherein the voxel representation is capable of being applied to a software application at the computing device, wherein the software application relates to one or more of 3D gaming, computer vision, augmented reality, space navigation, mapping, objects collection detection, national defense tasks, scientific research, archeological exploration, geological analysis, and analysis of spaces filled with solid objects.

Example 26 includes the subject matter of Example 19, wherein the plurality of data sources comprise one or more of government data sources, commercial data sources, and private or organizational data sources, wherein the government data sources include government-administered satellites, other physical entities, websites or other software applications, wherein the commercial data sources include business-administered satellites, other physical entities, websites or other software applications, and wherein the private data sources includes still or movable personal image capturing devices, other physical entities, websites or other software applications.

Example 27 includes the subject matter of Example 19, wherein the image capturing devices comprise one or more of two-dimensional (2D) cameras, 3D cameras, infrared cameras, and depth-sensing cameras, wherein the images comprise one or more of photographs, video streams, animations, and graphical representations, wherein the objects comprise one or more 3D physical objects, and wherein the space comprises a physical area or range.

Some embodiments pertain to Example 28 includes an apparatus comprising: means for detecting, by a computing device, a plurality of data sources hosting image capturing devices capable of capturing images of objects in a space, wherein the images are capable of being received by the computing device; means for tagging trust metrics to the images based on credibility of the plurality of data sources, wherein a trust metrics to indicate veracity of a corresponding image; means for aggregating the images into an aggregated image representation; and means for generating a voxel representation of the aggregated image representation such that the images are presented as voxel images, wherein veracities of the voxel images are secured based on tagging of the trust metrics to their corresponding images.

Example 29 includes the subject matter of Example 28, further comprising: means for communicating the voxel representation to one or more computing devices for viewing by one or more users having access to the one or more computing devices, wherein the voxel representation is communicated over one or more networks including a cloud network, a proximity network, or the Internet, wherein a voxel represents a value on a grid in a three-dimensional (“3D”) space, wherein a voxel image represents the grid.

Example 30 includes the subject matter of Example 28, further comprising: means for determining the trust metrics based on evaluation of information relating to one or more of the images, the image capturing devices, the plurality of data sources, and administrators associated with the plurality of data sources, wherein the veracities indicate trustworthiness of the voxel images.

Example 31 includes the subject matter of Example 30, wherein the information comprises data or metadata indicating the credibility of one or more of the images, the images capturing devices, the plurality of data sources, and the administrators associated with the plurality of data sources, wherein the credibility reflects one or more of reliability, dependability, consistency, and quality of one or more of the images, the images capturing devices, the plurality of data sources, and the administrators associated with the plurality of data sources.

Example 32 includes the subject matter of Example 31, further comprising: means for receiving and means for maintaining the information based on one or more of real-time correspondence, live broadcasts, historical patterns, changing arrangements, environmental considerations, political situations, and geographical contemplations.

Example 33 includes the subject matter of Example 28, further comprising: means for filtering out or means for altering one or more images from the aggregated image representation prior to generation of the voxel representation, wherein the one or more images are filtered out or altered based on a user profile or a set of user preferences associated with a user having access to a computing device of the one or more computing devices.

Example 34 includes the subject matter of Example 33, further comprising: means for offering a user interface at the computing device such that the voxel representation is capable of being accessed, viewed, and modified via the user interface at the computing device, wherein the voxel representation is capable of being applied to a software application at the computing device, wherein the software application relates to one or more of 3D gaming, computer vision, augmented reality, space navigation, mapping, objects collection detection, national defense tasks, scientific research, archeological exploration, geological analysis, and analysis of spaces filled with solid objects.

Example 35 includes the subject matter of Example 28, wherein the plurality of data sources comprise one or more of government data sources, commercial data sources, and private or organizational data sources, wherein the government data sources include government-administered satellites, other physical entities, websites or other software applications, wherein the commercial data sources include business-administered satellites, other physical entities, websites or other software applications, and wherein the private data sources includes still or movable personal image capturing devices, other physical entities, websites or other software applications.

Example 36 includes the subject matter of Example 28, wherein the image capturing devices comprise one or more of two-dimensional (2D) cameras, 3D cameras, infrared cameras, and depth-sensing cameras, wherein the images comprise one or more of photographs, video streams, animations, and graphical representations, wherein the objects comprise one or more 3D physical objects, and wherein the space comprises a physical area or range.

Example 37 includes at least one non-transitory machine-readable medium comprising a plurality of instructions, when executed on a computing device, to implement or perform a method as claimed in any of claims or examples 10-18.

Example 38 includes at least one machine-readable medium comprising a plurality of instructions, when executed on a computing device, to implement or perform a method as claimed in any of claims or examples 10-18.

Example 39 includes a system comprising a mechanism to implement or perform a method as claimed in any of claims or examples 10-18.

Example 40 includes an apparatus comprising means for performing a method as claimed in any of claims or examples 10-18.

Example 41 includes a computing device arranged to implement or perform a method as claimed in any of claims or examples 10-18.

Example 42 includes a communications device arranged to implement or perform a method as claimed in any of claims or examples 10-18.

Example 43 includes at least one machine-readable medium comprising a plurality of instructions, when executed on a computing device, to implement or perform a method or realize an apparatus as claimed in any preceding claims or examples.

Example 44 includes at least one non-transitory machine-readable medium comprising a plurality of instructions, when executed on a computing device, to implement or perform a method or realize an apparatus as claimed in any preceding claims or examples.

Example 45 includes a system comprising a mechanism to implement or perform a method or realize an apparatus as claimed in any preceding claims or examples.

Example 46 includes an apparatus comprising means to perform a method as claimed in any preceding claims or examples.

Example 47 includes a computing device arranged to implement or perform a method or realize an apparatus as claimed in any preceding claims or examples.

Example 48 includes a communications device arranged to implement or perform a method or realize an apparatus as claimed in any preceding claims or examples.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1-23. (canceled)

24. An apparatus to facilitate generation of voxel representations and assignment of trust metrics, comprising:
detection/reception logic to detect a plurality of data sources hosting image capturing devices capable of capturing images of objects in a space, wherein the detection/reception logic is further to receive the images;
trust metrics tagging logic (“trust logic”) to tag trust metrics to the images based on credibility of the plurality of data sources, wherein a trust metrics to indicate veracity of a corresponding image;
aggregation logic to aggregate the images into an aggregated image representation; and
generation logic to generate a voxel representation of the aggregated image representation such that the images are presented as voxel images, wherein veracities of the voxel images are secured based on tagging of the trust metrics to their corresponding images.

25. The apparatus of claim 24, further comprising:
communication/compatibility logic to communicate the voxel representation to one or more computing devices for viewing by one or more users having access to the one or more computing devices, wherein the voxel representation is communicated over one or more networks including a cloud network, a proximity network, or the Internet, wherein a voxel represents a value on a grid in a three-dimensional (“3D”) space, wherein a voxel image represents the grid.

26. The apparatus of claim 24, further comprising: data and trust evaluation logic (“evaluation logic”) to determine the trust metrics based on evaluation of information relating to one or more of the images, the image capturing devices, the plurality of data sources, and administrators associated with the plurality of data sources, wherein the veracities indicate trustworthiness of the voxel images.

27. The apparatus of claim 26, wherein the information comprises data or metadata indicating the credibility of one or more of the images, the images capturing devices, the plurality of data sources, and the administrators associated with the plurality of data sources, wherein the credibility reflects one or more of reliability, dependability, consistency, and quality of one or more of the images, the images capturing devices, the plurality of data sources, and the administrators associated with the plurality of data sources.

28. The apparatus of claim 26, further comprising: metadata trust logic to receive and maintain the information based on one or more of real-time correspondence, live broadcasts, historical patterns, changing arrangements, environmental considerations, political situations, and geographical contemplations.

29. The apparatus of claim 24, further comprising: filtering logic to filter out or alter one or more images from the aggregated image representation prior to generation of the voxel representation, wherein the one or more images are filtered out or altered based on a user profile or a set of user preferences associated with a user having access to a computing device of the one or more computing devices.

30. The apparatus of claim 29, further comprising: user interface logic to offer a user interface at the computing device such that the voxel representation is capable of being accessed, viewed, and modified via the user interface at the computing device, wherein the voxel representation is capable of being applied to a software application at the computing device, wherein the software application relates to one or more of 3D gaming, computer vision, augmented reality, space navigation, mapping, objects collection detection, national defense tasks, scientific research, archeological exploration, geological analysis, and analysis of spaces filled with solid objects.

31. The apparatus of claim 24, wherein the plurality of data sources comprise one or more of government data sources, commercial data sources, and private or organizational data sources, wherein the government data sources include government-administered satellites, other physical entities, websites or other software applications, wherein the commercial data sources include business-administered satellites, other physical entities, websites or other software applications, and wherein the private data sources includes still or movable personal image capturing devices, other physical entities, websites or other software applications.

32. The apparatus of claim 24, wherein the image capturing devices comprise one or more of two-dimensional (2D) cameras, 3D cameras, infrared cameras, and depth-sensing cameras, wherein the images comprise one or more of photographs, video streams, animations, and graphical representations, wherein the objects comprise one or more 3D physical objects, and wherein the space comprises a physical area or range.

33. A method for facilitating generation of voxel representations and assignment of trust metrics, comprising:
detecting, by a computing device, a plurality of data sources hosting image capturing devices capable of capturing images of objects in a space, wherein the images are capable of being received by the computing device;
tagging trust metrics to the images based on credibility of the plurality of data sources, wherein a trust metrics to indicate veracity of a corresponding image;
aggregating the images into an aggregated image representation; and
generating a voxel representation of the aggregated image representation such that the images are presented as voxel images, wherein veracities of the voxel images are secured based on tagging of the trust metrics to their corresponding images.

34. The method of claim 33, further comprising: communicating the voxel representation to one or more computing devices for viewing by one or more users having access to the one or more computing devices, wherein the voxel representation is communicated over one or more networks including a cloud network, a proximity network, or the Internet, wherein a voxel represents a value on a grid in a three-dimensional (“3D”) space, wherein a voxel image represents the grid.

35. The method of claim 33, further comprising: determining the trust metrics based on evaluation of information relating to one or more of the images, the image capturing devices, the plurality of data sources, and administrators associated with the plurality of data sources, wherein the veracities indicate trustworthiness of the voxel images.

36. The method of claim 35, wherein the information comprises data or metadata indicating the credibility of one or more of the images, the images capturing devices, the plurality of data sources, and the administrators associated with the plurality of data sources, wherein the credibility reflects one or more of reliability, dependability, consistency, and quality of one or more of the images, the images capturing devices, the plurality of data sources, and the administrators associated with the plurality of data sources.

37. The method of claim 35, further comprising: receiving and maintaining the information based on one or more of real-time correspondence, live broadcasts, historical patterns, changing arrangements, environmental considerations, political situations, and geographical contemplations.

38. The method of claim 33, further comprising: filtering out or altering one or more images from the aggregated image representation prior to generation of the voxel representation, wherein the one or more images are filtered out or altered based on a user profile or a set of user preferences associated with a user having access to a computing device of the one or more computing devices.

39. The method of claim 38, further comprising: offering a user interface at the computing device such that the voxel representation is capable of being accessed, viewed, and modified via the user interface at the computing device, wherein the voxel representation is capable of being applied to a software application at the computing device, wherein the software application relates to one or more of 3D gaming, computer vision, augmented reality, space navigation, mapping, objects collection detection, national defense tasks, scientific research, archeological exploration, geological analysis, and analysis of spaces filled with solid objects.

40. The method of claim 33, wherein the plurality of data sources comprise one or more of government data sources, commercial data sources, and private or organizational data sources, wherein the government data sources include government-administered satellites, other physical entities, websites or other software applications, wherein the commercial data sources include business-administered satellites, other physical entities, websites or other software applications, and wherein the private data sources includes still or movable personal image capturing devices, other physical entities, websites or other software applications.

41. The method of claim 33, wherein the image capturing devices comprise one or more of two-dimensional (2D) cameras, 3D cameras, infrared cameras, and depth-sensing cameras, wherein the images comprise one or more of photographs, video streams, animations, and graphical representations, wherein the objects comprise one or more 3D physical objects, and wherein the space comprises a physical area or range.

42. At least one machine-readable storage medium comprising a plurality of instructions stored thereon, the instructions when executed on a computing device, cause the computing device to:
detect a plurality of data sources hosting image capturing devices capable of capturing images of objects in a space, wherein the images are capable of being received by the computing device;
tag trust metrics to the images based on credibility of the plurality of data sources, wherein a trust metrics to indicate veracity of a corresponding image;
aggregate the images into an aggregated image representation; and
generate a voxel representation of the aggregated image representation such that the images are presented as voxel images, wherein veracities of the voxel images are secured based on tagging of the trust metrics to their corresponding images.

43. The machine-readable storage medium of claim 42, wherein the computing device is further to: communicate the voxel representation to one or more computing devices for viewing by one or more users having access to the one or more computing devices, wherein the voxel representation is communicated over one or more networks including a cloud network, a proximity network, or the Internet, wherein a voxel represents a value on a grid in a three-dimensional (“3D”) space, wherein a voxel image represents the grid.

44. The machine-readable storage medium of claim 42, wherein the computing device is further to: determine the trust metrics based on evaluation of information relating to one or more of the images, the image capturing devices, the plurality of data sources, and administrators associated with the plurality of data sources, wherein the veracities indicate trustworthiness of the voxel images,
wherein the information comprises data or metadata indicating the credibility of one or more of the images, the images capturing devices, the plurality of data sources, and the administrators associated with the plurality of data sources, wherein the credibility reflects one or more of reliability, dependability, consistency, and quality of one or more of the images, the images capturing devices, the plurality of data sources, and the administrators associated with the plurality of data sources.

45. The machine-readable storage medium of claim 44, wherein the computing device is further to: receive and maintain the information based on one or more of real-time correspondence, live broadcasts, historical patterns, changing arrangements, environmental considerations, political situations, and geographical contemplations.

46. The machine-readable storage medium of claim 42, wherein the computing device is further to:
filter out or alter one or more images from the aggregated image representation prior to generation of the voxel representation, wherein the one or more images are filtered out or altered based on a user profile or a set of user preferences associated with a user having access to a computing device of the one or more computing devices; and
offer a user interface at the computing device such that the voxel representation is capable of being accessed, viewed, and modified via the user interface at the computing device, wherein the voxel representation is capable of being applied to a software application at the computing device, wherein the software application relates to one or more of 3D gaming, computer vision, augmented reality, space navigation, mapping, objects collection detection, national defense tasks, scientific research, archeological exploration, geological analysis, and analysis of spaces filled with solid objects.

47. The machine-readable storage medium of claim 42, wherein the plurality of data sources comprise one or more of government data sources, commercial data sources, and private or organizational data sources, wherein the government data sources include government-administered satellites, other physical entities, websites or other software applications, wherein the commercial data sources include business-administered satellites, other physical entities, websites or other software applications, and wherein the private data sources includes still or movable personal image capturing devices, other physical entities, websites or other software applications.

48. The machine-readable storage medium of claim 42, wherein the image capturing devices comprise one or more of two-dimensional (2D) cameras, 3D cameras, infrared cameras, and depth-sensing cameras, wherein the images comprise one or more of photographs, video streams, animations, and graphical representations, wherein the objects comprise one or more 3D physical objects, and wherein the space comprises a physical area or range.
